(19) United States
(12) Patent Application Publication
(10) Pub. No.: US 2001/0024192 A1
(43) Pub. Date: Sep. 27, 2001

(54) Ergonomic mouse and method of using the same

(76) Inventor: Stephen H. Lewis, New York, NY (US)

Correspondence Address: NIXON PEABODY LLP, Suite 2400, 437 Madison Avenue, New York, NY, 10022, US

(21) Appl. No.: 09/774,843

(22) Filed: Jan. 31, 2001

Related U.S. Application Data
(60) Provisional application No. 60/179,297, filed on Jan. 31, 2000.

(51) Int. Cl. G09G 5/08

(52) U.S. Cl. 345/163

(57) ABSTRACT

An ergonomic mouse and method of using the same. A cursor control device is provided including a base, an outer shell mounted to the base, electronic circuitry housed within the device for cursor control, a first movable pad sensor for input activation and device control, and a sensor system for translating device movement to cursor movement on a computer display such that the cursor tracks corresponding translational movement of the device. A communications link connects the device to a central processing unit. The outer shell of the body is constructed of at least one moldable or pliable material to allow the user to readily shape the outer shell into a selected form. The pad sensor is desirably movable about the material surface for ready positioning by the user, for enhanced comfort and minimal hand injury.

### BACKGROUND OF THE INVENTION

The present invention relates generally to peripherals for program controlled apparatus and, more particularly, to an improved device for controlling input to desktop computers or the like.

Widespread use of input devices in the 21^{st} century has placed an ever increasing demand for easier and more comfortable ways of inputting information into computers, and controlling manipulation of data thereafter. In recent years, input devices such as the “mouse” have become particularly popular not only because of their relatively small size and compactness, but also their comfort and simplicity of use. Conventional mice are formed in an ergonomically useful shape in an effort to provide a comfortable feel for the user's hand during operation. A fixed or static, plastic molded outer shell is typically used in order to conform to a wide range of user hand sizes. While the shell may be formed in a variety of different shapes, each has been found to suffer from the same problem. In particular, for a given shape, the user exercises the same muscles and movement patterns repeatedly and continuously, resulting in repetitive stress and accompanying fatigue or injury.

An input device is, therefore, desired that not only prevents repetitive hand fatigue, stress and injury, but is also efficient, comfortable and easy to use.

### SUMMARY OF THE INVENTION

According to one aspect of the present invention, there is provided a cursor control device including a base, an outer shell mounted to the base, electronic circuitry housed within the device for controlling the cursor, a first movable pad sensor for input activation and device control, and a sensor system for translating device movement to cursor movement on a computer display such that the cursor tracks corresponding translational movement of the device. A communications link is provided for connecting the device to a central processing unit. The outer shell of the body is constructed of at least one moldable material that allows the user to readily mold the shape of the outer shell to a selected form. The pad sensor is movable about the material surface for ready positioning by the user so as to provide enhanced comfort and minimize hand injury.

In accordance with another aspect of the present invention is an information input control device, which includes a base, an outer shell mounted to the base, electronic circuitry housed within the device for controlling the cursor, a first movable pad sensor for input activation and device control, and a sensor system for translating device movement to corresponding data movement on a computer display such that the data tracks corresponding translational movement of the device. A communications link is provided for connecting the device to a central processing unit. The outer shell of the body is constructed of at least one pliable material that allows the user to readily change the shape of the outer shell to a selected form. The pad sensor is movable about the material surface for ready positioning by the user so as to provide enhanced comfort and minimize hand injury.

According to a further aspect of the present invention is a program controlled apparatus having a cursor control device. The device includes a base, an outer shell mounted to the base, electronic circuitry housed within the device for controlling the cursor, a first movable pad sensor for input activation and device control, and a sensor system for translating device movement to cursor movement on a computer display such that the cursor tracks corresponding translational movement of the device. A communications link is provided for connecting the device to a central processing unit. The outer shell of the body is constructed of at least one material suitable for allows the user to readily change the shape of the outer shell to a selected form. The pad sensor is movable about the material surface for ready positioning by the user so as to provide enhanced comfort and minimize hand injury.

In accordance with still another aspect of the present invention is a method of using a cursor control device which comprises the steps of:

(i) placing a user's hand on an outer shell of the device, the outer shell being formed of a pliable material;

(ii) applying pressure from the user's hand to the outer shell so as to form the shell into a contour like that of the user's palm;

(iii) adhering a sensor pad of the device to a selected location on the outer shell so as to allow comfortable engagement of the pad with at least one of the user's fingers; and

(iv) engaging the pad by said one of the user's fingers so as to effect cursor activation and control.

According to still another aspect of the present invention is a method of using a cursor control device which comprises the steps of:

(i) placing a user's hand on an outer shell of the device, the outer shell being formed of a moldable material;

(ii) applying pressure from the user's hand to the outer shell so as to form the shell into a contour like that of the user's palm;

(iii) adhering a sensor pad of the device to a selected location on the outer shell so as to allow comfortable engagement of the pad with at least one of the user's fingers; and

(iv) engaging the pad by said one of the user's fingers so as to effect cursor activation and control.

It is, therefore, an object of the present invention to provide a durable, reliable input and cursor control device that is comfortable and easy to use.

Another object of the present invention is to provide a moldable, variable shape, hand-held input device that is economical and prevents repetitive stress fatigue or injury.

A further object of the present invention is to provide an improved ergonomic device for data input.

Still another object of the present invention is to provide a computer mouse which conforms to the shape of any user's hand.

Yet another object of the present invention is to provide the user with the option to not only vary the shape of a computer mouse, but also its orientation and the position of the activation buttons thereof.

Still a further object of the present invention is to reduce boredom and/or monotony often associated with repetitive data input and control activities.

Yet a further object of the present invention is to provide amusement or entertainment to the user.

Another object of the present invention is to provide an input device that is not only ergonomically beneficial, but also fun to play with.

The present invention will now be further described by reference to the attached drawings which are not intended to limit the accompanying claims.

### BRIEF DESCRIPTION OF THE DRAWINGS

FIG. 1 is a perspective view of an ergonomic mouse, according to one aspect of the present invention;

FIG. 2 is an exploded view of the ergonomic mouse shown in FIG. 1, indicating an outer shell of a moldable or pliable material, a base, a circuit board, and tethered, movable pad sensors;

FIG. 3 is a plan view of the ergonomic mouse shown in FIG. 1;

FIG. 4 is a side view of the ergonomic mouse shown in FIG. 1;

FIG. 5 is a side view of an ergonomic mouse, according to another aspect of the present invention;

FIG. 6 is a sectional view of a moldable or pliable material for an ergonomic mouse, according to a further aspect of the present invention;

FIG. 7 is a sectional view of an ergonomic mouse according to still another aspect of the present invention; and

FIG. 8 is a program controlled apparatus, according to one aspect of the present invention.

The same numerals are used throughout the figure drawings to designate similar elements. Still other objects and advantages of the present invention will become apparent from the following description of the preferred embodiments.

### DETAILED DESCRIPTION OF THE PREFERRED EMBODIMENTS

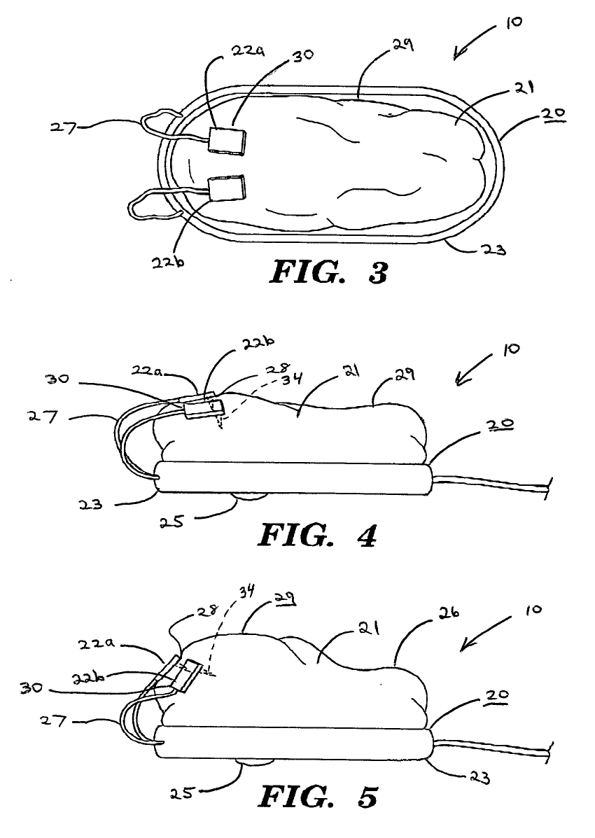

Referring now to the drawings and, more particularly, to FIGS. 1-8, there is shown generally a specific, illustrative ergonomic mouse 10 according to various aspects of the present invention. Generally speaking, as shown in FIG. 1, the present invention relates to a mouse having a body 11 constructed of at least one moldable, malleable, or pliable material 12. Moveable mouse “click” or activation buttons 13 allow the user to position (and/or re-position) the buttons at any desired location on moldable or pliable shell 14 for enhanced comfort and ease of use. Likewise, since the mouse shell is constructed of a moldable or pliable material, the mouse exterior may be formed in a variety of different hand-conforming shapes as often as desired, also for comfort and ease of use.

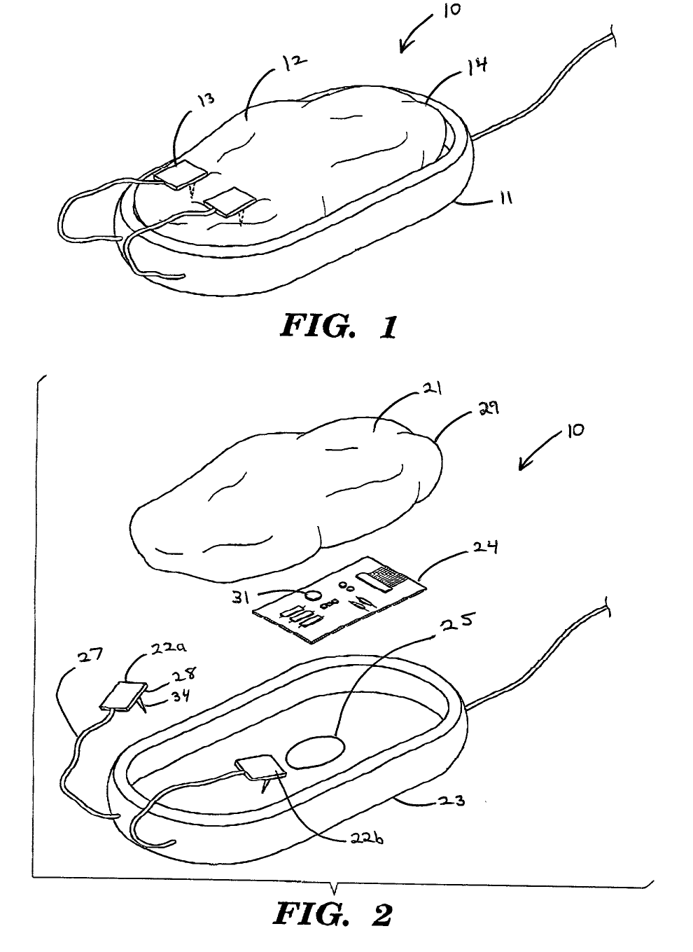

According to one aspect of the present invention, as best seen in FIGS. 2-4, the device includes a cursor control device 20 with standard or conventional mouse parts and components, e.g., generally those of the IntelliMouse® 1.1A PS/2 Compatible, except that outer shell 29 of the body is constructed of at least one moldable or pliable material 21 and activation buttons 22a, 22b are moveable. The shape of the body may be readily changed or reformed by the user, manually or otherwise, and the buttons may be readily positioned and/or re-positioned by the user, for enhanced comfort and minimal hand injury.

The mouse preferably includes a base unit 23 containing electronic circuitry 24, e.g., a conventional electronic input control circuit board or the like, best seen in FIG. 2, and a tracking ball or other conventional sensing system 25 for input activation and control tasks. The sensing system is desirably in a low profile type configuration to rise as little as possible above the base or bottom surface of the mouse. One objective of this feature is to maximize the amount of volumetric space above the base for receiving the moldable or pliable material.

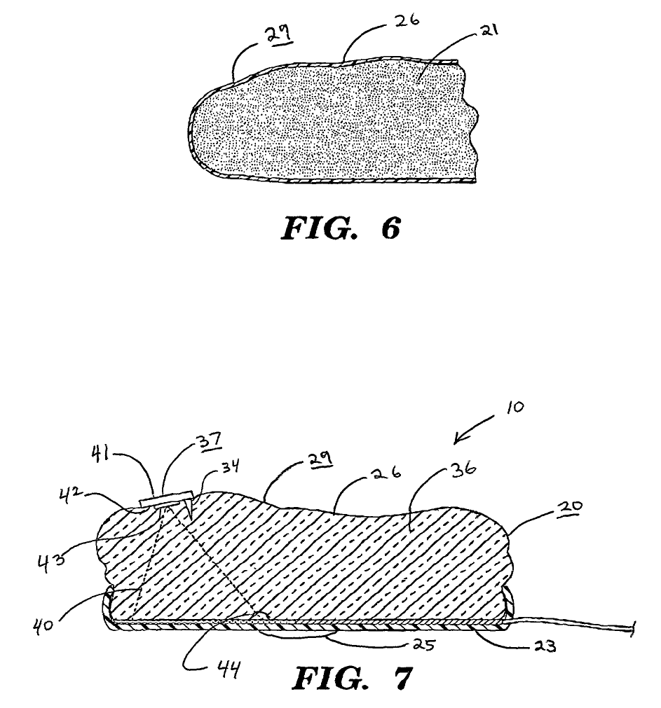

The material, e.g., Play-Doh®, molding clay or the like, is mounted on the upper surface of the base, thereby forming the body of the mouse. Desirable material characteristics are that it be easy to reshape, and readily hold its shape once it has been molded. In this manner, as illustrated in FIGS. 4 and 5, the user can readily mold and shape the body of the mouse at will. The moldable material may be exposed to the user's hand, encased in a protective skin 26 such as a relatively thin plastic covering, as shown in FIG. 6, or in a combination of the two, i.e., with exposed and covered portions of the material.

Alternatively or concurrently therewith, reshaping by the user is accomplished using extensible/retractable fixed molded plastic parts, movably attached to the base of the mouse using extending rods or other means for adjustment and/or mouse body contortion.

Advantageously, the user can easily modify the shape of the mouse to conform with his or her hand and, thereby, permit the user to use different muscles and stress the hand in different ways depending on the shape to which the mouse has been remolded. Mouse shape may also be reformed readily to accommodate another user's hand. This variation in shape not only enhances comfort but also provides relief from repetitive stress injuries.

In addition, the mouse buttons or pad sensors are readily movable to accommodate reshaping of the mouse body and user preference. According to one aspect of the present invention, the buttons are tethered to the base unit using relatively small, flexible cables 27 terminating in a button panel or pad 28 placed at a selected location 30 on the mouse body, preferably on an exterior portion of the material surface. By changing the position of the pad, variability of the mouse's shape is enhanced and different hand muscles are engaged in use.

Although the pads may be located anywhere on the exterior (or interior) of the pliable material, it will be understood by those skilled in the art that suitable locations may depend on particulars aspects of the user's hand including, but not limited to, hand size, proportion, reach, desired orientation, comfort and/or general preference of the user. For instance, the position or location of the pad may be readily changed simply to add variety to the otherwise monotonous task of mouse use.

Further more, an object of the present invention, alternatively or concurrently therewith, is to provide amusement or entertainment to the user, e.g., the “squishy” characteristics of the outer shell make the mouse not only ergonomically beneficial, but also something that may be played with by children or adult users. Also, eyes or other ornaments may be placed on the sensor buttons or other portions of the mouse for added entertainment and/or play-value.

In an alternative embodiment, the mouse buttons desirably protrude from the base unit on jointed support rods. In this respect, the buttons are adjustable manually by sliding them along an arc or linear track on the fixed body of the mouse. In another alternative embodiment, it is preferred that the buttons also be adjustable and be attached from inside the body of the mouse to the base unit.

Turning now to materials of construction, the moldable or pliable material is preferably exposed to the user's hand directly or, in the alternative, inside relatively thin plastic covering 26. Generally speaking, the manner of material exposure depends on the type or nature of the material used, as will be appreciated by those skilled in the art. As for the base and other components of the mouse, conventional materials are used, e.g., plastics and other polymeric materials.

According to one aspect of the present invention, the material is selected from a variety of non-toxic, moldable or pliable, inert substances, including a non-oily, clay-like composition, GAK™, Play-Doh®, Silly Putty®, molding clay, a deformable polymeric material such as a temperature-sensitive plexiglass, a malleable metallic substance, a conventional infrared permeable, malleable black plastic, or a beanbag-like cloth filled with generally small or granular beads which, in operation, may be readily deformed to create and hold different shapes. Likewise, the button pads desirably adhere to the pliable mouse body surface using teeth 34 which grab, dig into, or otherwise penetrate the clay-like material. Alternatively or concurrently therewith, a conventional Velcro®-like strip material is used for adherence, e.g., for catching on the cloth exterior of the beanbag-style exterior cloth.

According to yet another aspect of the present invention is a moldable or pliable material that is transparent (or translucent) 36 to electronic signals or the like, e.g., a plastic bag-encased clear gel, in combination with movable, non-tethered mouse pads 37 adapted to transmit, i.e., by sound or otherwise, through the material to effect activation function of the input device. A mouse of this general description is illustrated in FIG. 7.

Each pad or button, there being desirably at least two, is preferably adapted to emit a selected, distinctive sound, such as a click or “chirp”(mechanically or electronically generated), when pressed. The sound is received by a relatively small microphone 38 preferably associated with the base, e.g., on or adjacent to electronic circuitry 24.

According to one aspect of the invention, each button has a different “chirp” so that it may be readily distinguished. This may be done by using different frequencies or by selected sound signatures, i.e., a specific characteristic in the envelope of the “chirp” that would allow reliable distinction between the sound made by each button. For example, a double vs. single sound may be used such as a “dip dip” vs. a single “dip”. Details of these systems are considered known by those skilled in the art and further description is considered unnecessary for purposes of illustrating the present invention.

In accordance with another aspect of the present invention is a button that emits a “chirp” mechanically. This is desirable with some designs as it requires no power or electronics in the buttons themselves, and a relatively inexpensive conventional, circuit board mounted microphone 31. Since the sound emitted need only travel a relatively short distance, e.g., about 2 inches, the electronics may be tuned to hear only the selected sound or “chirp” emitted. Accordingly, the likelihood of interference from ambient noise would be minimized.

Alternatively or concurrently, a light-penetrable moldable material 39 is used with infrared light 40 either generated or reflected by positionable buttons 41. For instance, each button mounts on its underside 42 an LED 43 that transmits a selected light pulse when that button is pressed or clicked. The light pulse, which is different for each of the buttons, is picked up by a light sensitive photodiode or photocell 44 on the electronic circuit board. Since infrared light penetrates opaque materials, not only are clear moldable materials suitable, but also opaque ones. Materials of this general description are known by those skilled in the art and further description is considered unnecessary for illustration of the present invention.

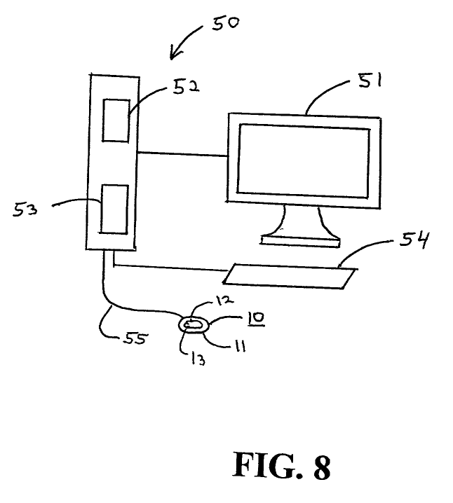

As shown in FIG. 8, a program controlled apparatus 50, e.g., a conventional Intel Pentium-based desktop computer, laptop or the like, is preferably used in connection with the mouse to received user input information and to house programming for inter-system communications. In particular, a display monitor 51 is provided, a communications modem 52, e.g., a conventional, Internet compatible modem, a central processing unit 53, ergonomic mouse 10, a keyboard 54 and/or other conventional input device. The mouse is joined or connected to the central processing unit by a conventional communications link 55 such as a flexible conductive cord. Optionally, the modem and display, alone or in combination, are housed with or, in the alternative, separately from the central processing unit.

Although the present invention has been shown and described for use with a conventional desktop computer, laptop or the like, its application to other devices will be appreciated giving consideration to the purpose for which the present invention is intended. In addition, while the concepts of the invention are illustrated for application to input devices, their use in other contexts with computing technology is considered within the spirit and scope of the present invention.

In operation, the device is used by initially placing the user's hand on an outer shell of the device, the outer shell being formed of a suitable moldable or pliable material. Pressure from the user's hand is then applied to the outer shell to form the material into a contour shape like that of the user's palm, or other shape comfortable or desirable to the user. Next, at least one sensor pad is adhered to a selected location on the outer shell so as to provide comfortable engagement between the pad and at least one of the user's fingers. Finally, the pad is engaged with one of the user's fingers so as to effect cursor activation and control.

Overall, the present invention advantageously allows the user to redefine the shape of the mouse exterior, and the location of the activation buttons as often as desired, thereby effecting continual change in the muscles used to control the mouse, as well as variation in the movements required for mouse manipulation. This can avoid repetitive movements known to cause hand stress or injury.

Various modifications and alterations to the present invention may be appreciated based on a review of this disclosure. These changes and additions are intended to be within the scope and spirit of this invention as defined by the following claims.

What is claimed is:

1. A cursor control device including a base, an outer shell mounted to the base, electronic circuitry housed within the device for cursor control, a first movable pad sensor for input activation and device control, and a sensor system for translating device movement to cursor movement on a computer display such that the cursor tracks corresponding translational movement of the device, a communications link connecting the device to a central processing unit, the outer shell of the body being constructed of at least one moldable material to allow the user to readily mold the shape of the outer shell to a selected form, and the pad sensor being movable about the material surface for ready positioning by the user so as to provide enhanced comfort and minimize hand injury.

2. The cursor control device set forth in claim 1 further including a second movable pad sensor for input activation and device control.

3. The cursor control device set forth in claim 1 wherein a tether having a signal conductive material connects the first pad sensor to the electronic circuitry for cursor control.

4. The cursor control device set forth in claim 1 wherein the first pad sensor communicates with the electronic circuitry through a selected sound emitted by the first pad, the electronic circuitry having a microphone for receiving and identifying the sound.

5. The cursor control device set forth in claim 1 wherein the first pad sensor communicates with the electronic circuitry through infrared light, the moldable material being light-penetrable for permitting passage of light between the sensor and the electronic circuitry.

6. An information input control device including a base, an outer shell mounted to the base, electronic circuitry housed within the device for device control, a first movable pad sensor for input activation and device control, and a sensor system for translating device movement to corresponding data movement on a computer display such that the data tracks corresponding translational movement of the device, a communications link connecting the device to a central processing unit, the outer shell of the body being constructed of at least one pliable material that allows the user to readily change the shape of the outer shell to a selected form, and the pad sensor being movable about the material surface for ready positioning by the user so as to provide enhanced comfort and minimize hand injury.

7. The cursor control device set forth in claim 6 further including a second movable pad sensor for input activation and device control.

8. The cursor control device set forth in claim 6 wherein a tether having a signal conductive material connects the first pad sensor to the electronic circuitry for cursor control.

9. The cursor control device set forth in claim 6 wherein the first pad sensor communicates with the electronic circuitry through a selected sound emitted by the first pad, the electronic circuitry having a microphone for receiving and identifying the sound.

10. The cursor control device set forth in claim 6 wherein the first pad sensor communicates with the electronic circuitry through infrared light, the pliable material being light-penetrable for permitting passage of light between the sensor and the electronic circuitry.

11. A program controlled apparatus having a cursor control device, the device including a base, an outer shell mounted to the base, electronic circuitry housed within the device for cursor control, a first movable pad sensor for input activation and device control, and a sensor system for translating device movement to cursor movement on a computer display such that the cursor tracks corresponding translational movement of the device, a communications link connecting the device to a central processing unit, the outer shell of the body being constructed of at least one material suitable for allowing the user to readily change the shape of the outer shell to a selected form, and the pad sensor being movable about the material surface for ready positioning by the user so as to provide enhanced comfort and minimize hand injury.

12. The cursor control device set forth in claim 11 further including a second movable pad sensor for input activation and device control.

13. The cursor control device set forth in claim 11 wherein a tether having a signal conductive material connects the first pad sensor to the electronic circuitry for cursor control.

14. The cursor control device set forth in claim 11 wherein the first pad sensor communicates with the electronic circuitry through a selected sound emitted by the first pad, the electronic circuitry having a microphone for receiving and identifying the sound.

15. The cursor control device set forth in claim 11 wherein the first pad sensor communicates with the electronic circuitry through infrared light, the material being light-penetrable for permitting passage of light between the sensor and the electronic circuitry.

16. A method of using a cursor control device which comprises the steps of:
(i) placing a user's hand on an outer shell of the device, the outer shell being formed of a pliable material;
(ii) applying pressure from the user's hand to the outer shell so as to form the shell into a contour like that of the user's palm;
(iii) adhering a sensor pad to a selected location on the outer shell so as to allow comfortable engagement of the pad with at least one of the user's fingers; and
(iv) engaging the pad by said one of the user's fingers so as to effect cursor activation and control.

17. A method of using a cursor control device which comprises the steps of:
(i) placing a user's hand on an outer shell of the device, the outer shell being formed of a moldable material;
(ii) applying pressure from the user's hand to the outer shell so as to form the shell into a contour like that of the user's palm;
(iii) adhering a sensor pad to a selected location on the outer shell so as to allow comfortable engagement of the pad with at least one of the user's fingers; and
(iv) engaging the pad by said one of the user's fingers so as to effect cursor activation and control.
